(19) United States
(12) Patent Application Publication
(10) Pub. No.: US 2026/0044201 A1
(43) Pub. Date: Feb. 12, 2026

(54) INTERACTION DEVICE

(71) Applicant: Sony Interactive Entertainment Inc., Tokyo (JP)

(72) Inventors: Shinichi HIRATA, Tokyo (JP); Toshiyuki ANDO, Tokyo (JP); Hitoshi NAKAMURA, Tokyo (JP)

(73) Assignee: Sony Interactive Entertainment Inc., Tokyo (JP)

(21) Appl. No.: 18/998,518

(22) PCT Filed: Aug. 1, 2022
(86) PCT No.: PCT/JP2022/029570

§ 371 Date: Jan. 26, 2025

(51) Int. Cl. G06F 3/01

(52) U.S. Cl. CPC G06F 3/011

(57) ABSTRACT

Disclosed is an interaction device that includes an exterior body, a radar sensor, and a detection target object. The exterior body is deformable. The radar sensor is disposed on the side of one inner surface of the exterior body, and configured to detect the location of a target within a detection range that is predetermined and extended from the one inner surface, including the inside of the exterior body, to the outside of an exterior body surface opposite the one inner surface. The detection target object is disposed inside the exterior body and within the detection range of the radar sensor, and configured to move according to the deformation of the exterior body.

### TECHNICAL FIELD

The present invention relates to an interaction device that receives user operations.

### BACKGROUND ART

Conventionally, interaction devices for controlling information processing devices such as home video game consoles have typically been formed by materials relatively resistant to elastic deformation, such as plastic materials.

However, in recent years, various types of interaction devices have been devised, for example, with the aim of enriching the user experience, for instance, in games.

### SUMMARY

### Technical Problem

For example, the interaction devices may be devices whose exterior is deformable, such as stuffed toys. However, it is not easy to detect and distinguish between a case where a user has brought his/her hand close to or merely touched the exterior and a case where the user has deformed the exterior in such interaction devices.

The present invention has been made in view of the above circumstances. An object of the present invention is to provide an interaction device that is able to detect and distinguish various types of user operations with a relatively simple configuration.

### Solution to Problem

In order to solve the above conventional problem, according to an aspect of the present invention, there is provided an interaction device further including an exterior body, a radar sensor, and a detection target object. The exterior body is deformable. The radar sensor is disposed on a side of one inner surface of the exterior body, and configured to detect a location of a target within a detection range that is predetermined and extended from the one inner surface, including an inside of the exterior body, to an outside of an exterior body surface opposite the one inner surface. The detection target object is disposed inside the exterior body and within the detection range, and configured to move according to deformation of the exterior body. A result of detection by the radar sensor is subjected to predetermined processing.

### Advantageous Effect of Invention

The present invention makes it possible to detect and distinguish various types of user operations with a relatively simple configuration.

### BRIEF DESCRIPTION OF DRAWINGS

FIG. 1 is a schematic configuration diagram illustrating an example of an interaction device according to an embodiment of the present invention.

FIG. 2 is a set of schematic explanatory diagrams illustrating examples of deformation of the interaction device according to the embodiment of the present invention.

FIG. 3 is a block diagram illustrating an example of a configuration of a circuit section in the interaction device according to the embodiment of the present invention.

FIG. 4 is an explanatory diagram illustrating an example of a radar sensor output that is processed by the interaction device according to the embodiment of the present invention.

FIG. 5 is a set of explanatory diagrams illustrating examples of the radar sensor output in the interaction device according to the embodiment of the present invention.

FIG. 6 is another set of explanatory diagrams illustrating examples of the radar sensor output in the interaction device according to the embodiment of the present invention.

FIG. 7 is a set of explanatory diagrams illustrating different layout examples of a detection target object of the interaction device according to the embodiment of the present invention.

FIG. 8 is another set of schematic explanatory diagrams illustrating examples of deformation of the interaction device according to the embodiment of the present invention.

### DESCRIPTION OF EMBODIMENT

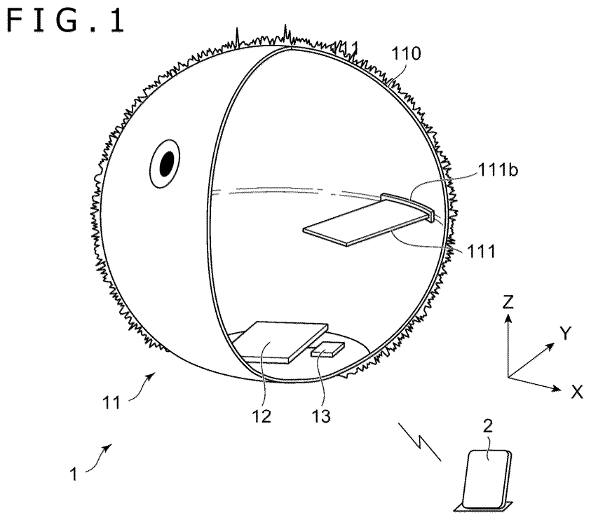

An embodiment of the present invention will now be described with reference to the accompanying drawings. As illustrated in FIG. 1, an interaction device 1 according to the embodiment of the present invention includes a device main body 11, a radar sensor 12, and a circuit section 13. These component elements are communicatively connected in a wireless or wired manner to an information processing device 2.

FIG. 1 is a schematic perspective view outlining the interaction device 1 according to the embodiment of the present invention with a part of the exterior of the interaction device 1 cut away to illustrate its inside. With reference to FIG. 1, the interaction device 1 is used while it is placed on a surface such as a desk or a floor. It is assumed in the following description that an up-down direction of the device main body 11 of the interaction device 1 is a Z-axis, and that an upward direction is a positive direction. Further, an X-axis and a Y-axis, which are normal to the Z-axis and mutually orthogonal to a plane on which the device main body 11 is placed, are defined as depicted in FIG. 1. Here, the X-axis is defined as a transverse direction of the device main body 11, and the Y-axis is defined as a front-rear direction of the device main body.

Note that, in the following description of the present embodiment, the shape and size and the ratio between the component elements of the interaction device 1, for example, are merely examples, and the other shapes and sizes and the size ratio between the component elements, for example, may differ from those exemplified.

Here, the device main body 11 includes an exterior body 110 that is formed by deformable materials. The exterior body 110 is configured to be deformable as described above. For example, the exterior body 110 may include materials that are elastically deformable and capable of transmitting signals of the radar sensor 12, namely, for example, polymer gel materials, such as silicon polymer gel materials and urethane gel materials, and various types of elastomer materials, such as polystyrene elastomers, olefin elastomers, polyvinyl chloride elastomers, polyurethane elastomers, polyester elastomers, and polyamide elastomers.

In the example of FIG. 1, the exterior body 110 of the device main body 11 has a substantially hollow spherical shape. Further, in one example of the present embodiment, cloth (fabric), such as fur, pile fabric, fake fur, or feather boa, may be attached to the outer surface of the exterior body 110. Such fabric may be attached to the outside of the exterior body 110, or may be detachable.

The exterior body 110 of the device main body 11 has a predetermined shape such as a sphere or a rectangular parallelepiped, for example, when no external force is applied to the exterior body 110. However, when a user applies an external force to the exterior body 110, for example, with a finger, the shape of the exterior body 110 changes in response to the applied external force.

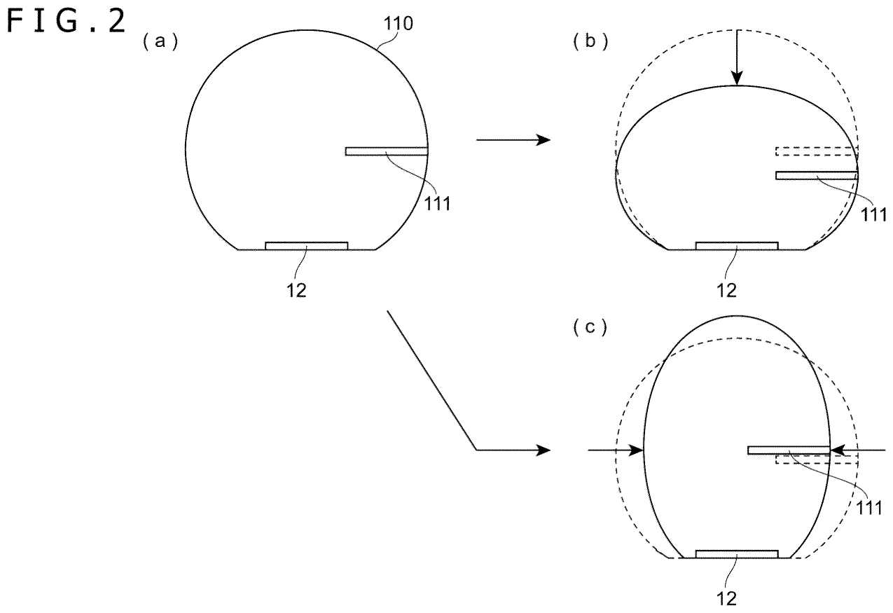

The inside of the exterior body 110 will now be described. As illustrated in FIG. 1, a detection target object 111 is disposed inside the exterior body 110, and configured to move according to the deformation of the exterior body 110. For example, the detection target object 111 may have a base 111b that is fastened to the inner surface of the exterior body 110, and may have a cantilever shape that projects inward into the exterior body 110. In the present example, as illustrated in FIG. 2, when the exterior body 110 is pressed in the up-down direction (Z-axis direction), the detection target object 111 also moves in the Z-axis direction (part (b) of FIG. 2). Further, when the exterior body 110 is compressed in a left-right direction and stretched in the Z-axis direction, the detection target object 111 also moves in the Z-axis direction (part (c) of FIG. 2).

Part (a) of FIG. 2 depicts the status of the exterior body 110 and the status of the detection target object 111 in a natural state (where no external force is applied). The dashed lines in parts (b) and (c) of FIG. 2 depict the status in part (a) of FIG. 2 by superimposition for comparison.

Further, in one example, the detection target object 111 may preferably be positioned at a predetermined distance from the surface of the exterior body 110 opposite the surface on which the radar sensor 12 is disposed (specifically, at a distance from the opposing surface of the exterior body 110 that can be distinguished by the output from the radar sensor 12), that is, may preferably be disposed at a position relatively close to the radar sensor 12. For example, in a case where the radar sensor 12 is disposed on the inner bottom surface of the exterior body 110, the detection target object 111 may be positioned below the half height of the exterior body 110.

However, in one example, the detection target object 111 need not be directly fastened to the inner surface of the exterior body 110. The base 111b may be fastened to an elastic body (e.g., rubber or a spring) that is attached to the exterior body 110 and configured to transmit deformation when the exterior body 110 is deformed.

The radar sensor 12 is disposed on the side of one inner surface of the exterior body 110. The example of FIG. 1 depicts the radar sensor 12 that is disposed on the inner bottom surface of the exterior body 110. Further, the radar sensor 12 emits a signal to a location within a detection range R, receives the signal reflected from a target located within the detection range R, and detects the location of the target. The detection range R is predetermined and includes the inside of the exterior body 110 extended from the surface on which the radar sensor 12 is disposed and also includes the outside of the surface of the exterior body 110 opposite the surface on which the radar sensor 12 is disposed. In the example of FIG. 1, the radar sensor 12 uses, as the detection range R, a range that begins from the bottom surface of the exterior body 110 and has an inverted cone shape (widening in the positive direction of the Z-axis). The detection range R covers a predetermined distance from the upper outside of the exterior body 110, and includes the detection target object 111.

In one example of the present embodiment, the radar sensor 12 is a pulse-Doppler radar or a frequency modulated continuous wave (FMCW) radar. Therefore, the method of setting the detection range R as described above is widely known, and will not be redundantly described in detail here.

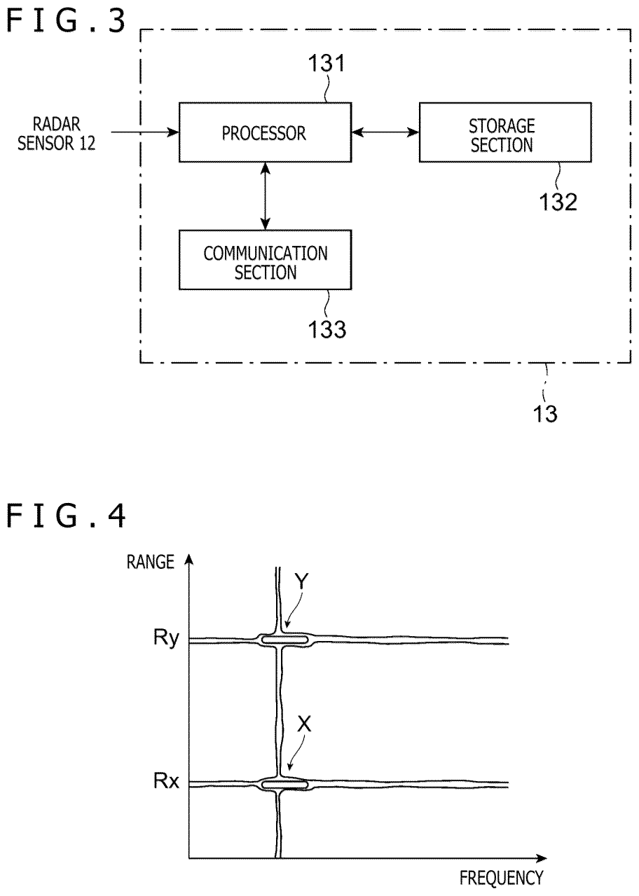

As illustrated in FIG. 3, the circuit section 13 includes a processor 131, a storage section 132, and a communication section 133. These component elements of the circuit section 13 are each operated by an unillustrated battery. This battery may be a secondary battery that can be recharged, for example, by wireless or wired power supply.

The processor 131 of the circuit section 13 includes a program control device such as a central processing unit (CPU), and operates according to a program stored in the storage section 132. In one example of the present embodiment, the processor 131 receives a target detection result from the radar sensor 12, and generates an operation information according to the received detection result. The operation information is generated for identifying a user operation. The operation of the processor 131 will be described later. Further, the processor 131 transmits the generated operation information to the information processing device 2 through the communication section 133.

The storage section 132 is, for example, a memory device, and configured to store the program to be executed by the processor 131. Further, the storage section 132 additionally operates as a work memory for the processor 131.

The communication section 133 is a wired communication interface, such as a universal serial bus (USB) interface, or a wireless communication interface, such as a Bluetooth (registered trademark) interface, and is communicatively connected in a wireless or wired manner to the information processing device 2. In accordance with instructions inputted from the processor 131, the communication section 133 transmits information to the information processing device 2. Further, the communication section 133 outputs, to the processor 131, the information received from the information processing device 2.

### Output From Radar Sensor

The radar sensor 12 acquires in-phase/quadrature-phase (IQ) signals by multiplying a signal in phase with a repeatedly emitted signal and a signal 90 degrees out of phase with the repeatedly emitted signal by a reflected wave signal, obtains the result of Fourier transform (FFT) of the IQ signals, and generates a waterfall chart illustrated in FIG. 4 by using the results of the past several Fourier transforms. The waterfall chart depicts the results of detection by the radar sensor 12 with frequency (Doppler velocity) on the horizontal axis and with distance (Range) on the vertical axis. The example of FIG. 4 indicates that detected targets X and Y are located at a distance Rx and at a distance Ry, respectively. The generation of such a waterfall chart based on signal outputs from the radar sensor 12 is widely known, and will not be redundantly described in further detail here.

### Generation of Operation Information

The processor 131 of the circuit section 13 receives, from the radar sensor 12, information regarding the results of detection which depict the waterfall chart. According to such results of detection, the processor 131 generates the operation information, for example, in a manner described below.

In the following example, it is assumed that the operation information generated by the processor 131 indicates a state where the user has brought his/her hand close to the interaction device 1 according to the present embodiment, a state where the user is in contact with the interaction device 1, a state where the user is moving his/her hand while maintaining contact with the interaction device 1 (a state where the user is stroking the interaction device 1), a state where the user is pressing the interaction device 1 in the up-down direction, and a state where the user is pressing the interaction device 1 in the left-right direction.

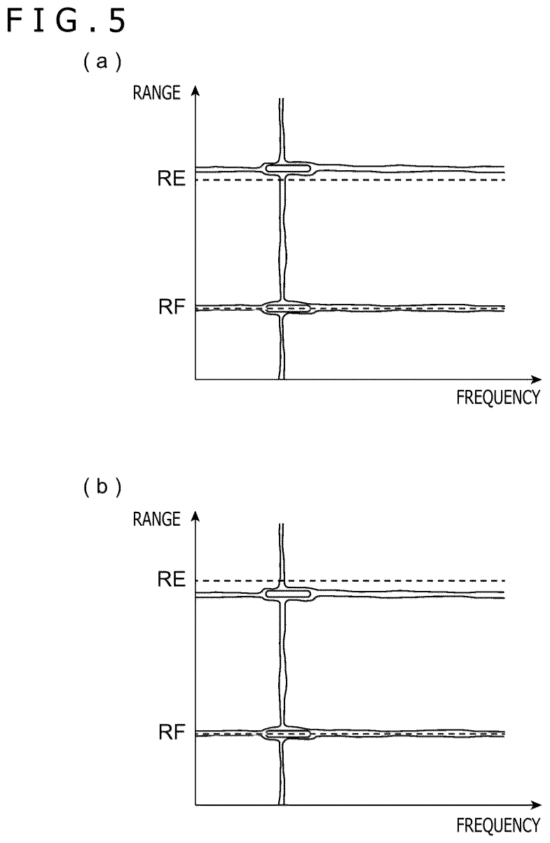

It is possible to determine whether the user has brought his/her hand close to the interaction device 1 or is in contact with the interaction device 1 depending on whether the output from the radar sensor 12 indicates that the target (a hand of the user in this case) is detected at a distance greater than a predetermined distance RE as illustrated in part (a) of FIG. 5 or indicates that the target (a hand of the user in this case) is detected at a distance close to the predetermined distance RE (the difference between the distance RE and the distance to the target is smaller than a predetermined threshold) as illustrated in part (b) of FIG. 5.

Further, whether the user is moving his/her hand toward or away from the interaction device 1 can be determined based on the Doppler velocity of the target located at a distance greater than the distance RE. Similarly, when the user is moving his/her hand while maintaining contact with the interaction device 1 (stroking the interaction device 1), the Doppler velocity of the target (a hand of the user) located at a distance close to the distance RE varies from the Doppler velocity in a state where the target is stationary. Therefore, whether the user is in simple contact with or stroking the interaction device 1 can be determined based on the variation in the Doppler velocity.

Here, the distance RE represents the distance between the radar sensor 12 and the inner surface of the exterior body 110 in a state where the exterior body 110 is not deformed. The distance RE is known. Parts (a) and (b) of FIG. 5 indicate that the detection target object 111 is detected at a predetermined distance RF. In a state where the exterior body 110 is not deformed, the distance RF between the radar sensor 12 and the detection target object 111 is also a known distance.

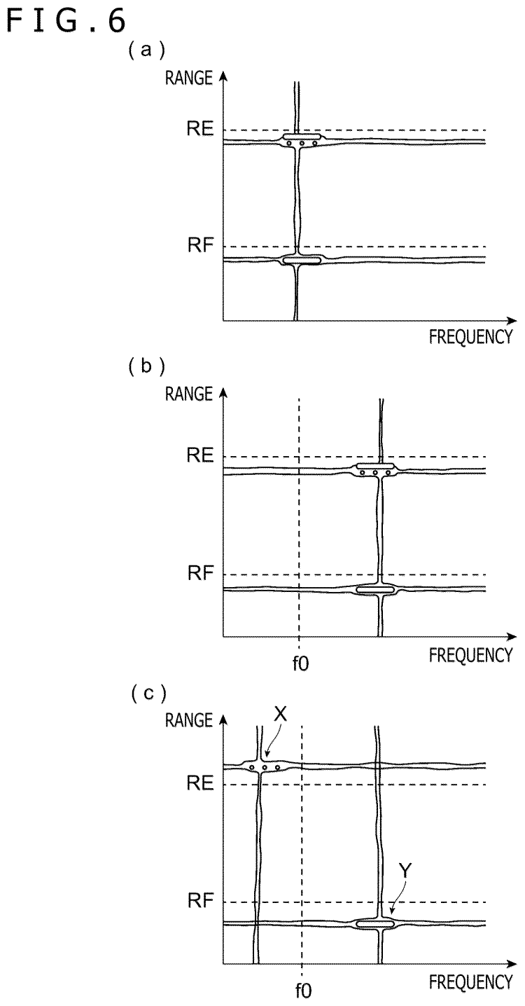

In the state where the user is pressing the interaction device 1 in the up-down direction, as illustrated in part (a) of FIG. 6, the detection target object 111 is also pressed in a similar manner, moved from an initial location (the location at the distance RF from the radar sensor 12) toward the bottom surface of the exterior body 110, and detected at a location where the distance to the radar sensor 12 is smaller than the RF. Further, the detection occurs at a location where the distance between the inner surface of the exterior body 110 and the radar sensor 12 is also smaller than the distance RE.

Consequently, in the state where the user is pressing the interaction device 1 in the up-down direction, as illustrated in part (b) of FIG. 6, a target (a hand of the user in this case) is detected at a distance smaller than the predetermined distance RE, and another target (detection target object 111) is detected at a distance smaller than the distance RF and is approaching the radar sensor 12. As a result, the above-mentioned targets are both detected because their Doppler velocity becomes relatively high (higher than a frequency f0 in a stationary state).

Incidentally, when the user presses the interaction device 1 and then attempts to remove his/her hand from the interaction device 1, a target (a hand of the user in this case) is detected at a distance smaller than the predetermined distance RE, and another target (detection target object 111) is detected at a distance smaller than the distance RF. However, since the targets are moving away from the radar sensor 12, the detection occurs because the Doppler velocity becomes relatively small.

Further, when the user presses the interaction device 1 in the left-right direction, the exterior body 110 stretches slightly in the up-down direction, so that the distance between the inner surface of the exterior body 110 and the radar sensor 12 becomes greater than the distance RE. Additionally, the detection target object 111 is also pressed in a similar manner and moved in a direction away from or toward the bottom surface of the exterior body 110 (the direction depends on the location of the detection target object 111 and the location where the detection target object 111 is pressed) from the initial location (the location at the distance RF from the radar sensor 12). Therefore, the distance between the detection target object 111 and the radar sensor 12 becomes greater or smaller than the RF.

Consequently, in the state where the user is pressing the interaction device 1 in the left-right direction, as illustrated in part (c) of FIG. 6, no target is detected at a distance close to the distance RE (because the user's hand is not above the exterior body 110), and only the inner surface of the exterior body 110 is detected at a distance greater than the distance RE (X). Part (c) of FIG. 6 depicts a state where the exterior body 110 is further stretching in the Z-axis direction. Moreover, in this state, the target (detection target object 111) is detected at a distance greater than the distance RF and smaller than the distance RE or detected at a distance smaller than the distance RF. Part (c) of FIG. 6 depicts a state where the target (detection target object 111) is detected at a distance smaller than the distance RF and is further approaching the radar sensor 12.

Each time the processor 131 receives the detection result from the radar sensor 12, the processor 131 acquires any one of the following items of operation information according to the received detection result.
(1) In a case where a target is detected at a distance R greater than the distance RE and detected at the distance RF: The user's hand is close to the interaction device 1 (a direction in which the user's hand is moving can be determined based on the Doppler velocity).
(2) In a case where the target is detected within a distance range from the distance RE and detected at the distance RF, and where the Doppler velocity indicates that the target is stationary: The user is in contact with the interaction device 1.
(3) In a case where the target is detected within the predetermined distance range from the distance RE and detected at the distance RF, and where the Doppler velocity indicates that the target is moving: The user is stroking the interaction device 1.
(4) In a case where the target is detected at the distance R greater than the distance RE and detected at a distance smaller than the distance RF, and where the Doppler velocity indicates that the target is approaching the radar sensor 12: The user is pressing the interaction device 1 in the up-down direction.
(5) In a case where there is no target at a distance close to the distance RE and a target is detected at a distance greater than the distance RF and smaller than the distance RE: The user is pressing the interaction device 1 in the left-right direction.

The processor 131 outputs the operation information which is acquired based on the determination illustrated above to the communication section 133, and causes the communication section 133 to transmit the operation information to the information processing device 2.

The information processing device 2 performs various types of processes by using the operation information received from the interaction device 1. For example, upon receiving the operation information indicating that the user is pressing the interaction device 1 in the up-down direction, the information processing device 2 performs, during the processing, for example, of a game application, a process of vertically shrinking and displaying a game character controlled by the user or another process.

### Deformation by Interaction Device Itself

The interaction device 1 according to the present embodiment may additionally include an actuator such as an electric motor (not depicted), drive the actuator in accordance with instructions from the processor 131, and let the actuator operate to deform the exterior body 110. As an example, a screw thread is formed on the outer circumference of a cylindrical body, one end of which is glued to the inner surface of the exterior body 110, and the screw thread on the cylindrical body is engaged with a ball screw that is rotationally driven by the actuator. In this example, when the actuator rotates the ball screw, the cylindrical body moves in a longitudinal direction of the ball screw, so that the exterior body 110 is pulled toward and pushed from the inner surface, thereby deforming the exterior body 110. However, this is merely an example, and other known methods may alternatively be adopted as long as the exterior body 110 can be deformed from the inner surface side in accordance with the instructions from the processor 131.

Further, in a case where the interaction device 1 includes the above-described mechanism for deforming the exterior body 110, the processor 131 may acquire the above-mentioned items of operation information (1) to (5) on the basis of the detection result upon each receipt of the detection result from the radar sensor 12, and may additionally make the following determination.
(6) In a case where there is no target at a distance close to the distance RE, a target (the detection target object 111 that moves due to the above-described deformation) is detected at a distance close to the distance RF, and the processor 131 itself has issued an instruction for deforming the exterior body 110, it is determined that the deformation is done without interaction with the user.

### Alternative Examples of Detection Target Object

In the foregoing description, it is assumed that one detection target object 111 is disposed in the exterior body 110 of the interaction device 1, and that the detection target object 111 has a cantilever shape that projects inward from the inner surface side of the exterior body 110. However, this is merely an example, and the detection target object 111 may alternatively be configured as described below.

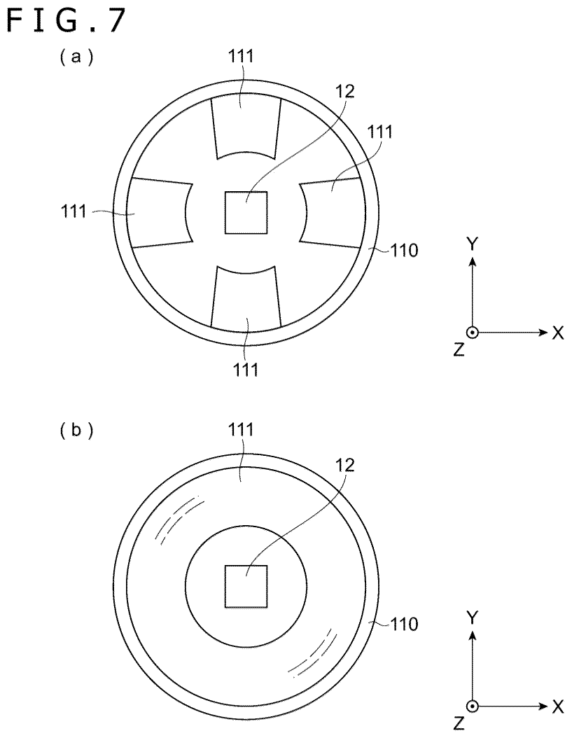

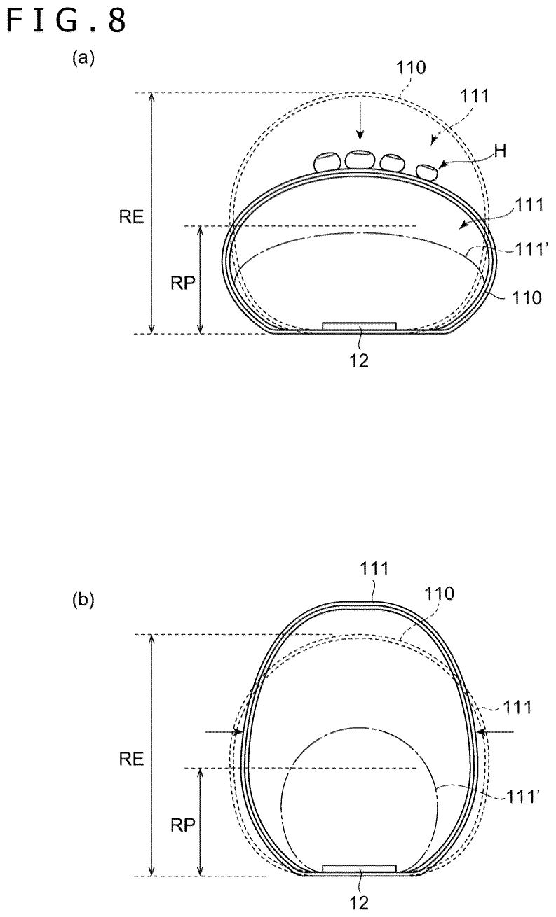

In one example of the present embodiment, the detection target object 111 may have a cantilever shape, and may be disposed in large numbers along the inner surface of the exterior body 110 as illustrated in part (a) of FIG. 7. In such an alternative case, a plurality of detection target objects 111 may be disposed in such a manner as to move by different amounts in response to the deformation of the exterior body 110. Specifically, the detection target objects 111 may include a detection target object 111 directly attached to the inner surface of the exterior body 110 and a detection target object 111 attached to the inner surface of the exterior body 110 via an elastic body such as hard rubber. In this example, the processor 131 detects the amount of movement of each detection target object 111, thereby making it possible to acquire more detailed information regarding, for example, the pressing force of the user.

Further, in another example, as illustrated in part (b) of FIG. 7, the detection target object 111 may have a hollow disk shape or a hollow polygonal shape (it is assumed that the outer circumferential shape of the detection target object 111 follows the inner shape of the exterior body 110), and the outer circumference may be coupled to the inner surface of the exterior body 110 directly or via an elastic body. FIG. 7 is a set of perspective views illustrating the exterior body 110 cut along a plane parallel to its transverse plane (XY plane).

In addition, in still another example of the present embodiment, the inside of the exterior body 110 may be filled with a filling material (i.e., fiber or another material that transmits waves emitted from a radar) that is not to be detected by the radar sensor 12. In this example, when the exterior body 110 is pressed and deformed, the filling material also deforms, so that the detection target object 111 becomes more likely to move in response to the deformation of the exterior body 110.

Moreover, in a case where the inside of the exterior body 110 is filled with the above-mentioned filling material as described above, the detection target objects 111 to be detected by the radar sensor may be dispersedly disposed. That is, in this example of the present embodiment, the detection target objects 111 are, for example, powder or fiber such as a metal filler or metal-coated filler detectable by the radar sensor 12, are mixed into the above-mentioned filling material for use, and are dispersedly disposed inside the exterior body 110.

In this example, in a case where the exterior body 110 of the interaction device 1 is not deformed, such as a case where the user's hand is close to the interaction device 1, the user is in contact with the interaction device 1, or the user is stroking the surface of the interaction device 1, the detection target objects 111 are detected at various points inside the exterior body 110. However, when the exterior body 110 is deformed, the detection target objects 111 dispersed inside the exterior body 110 move in response to such deformation, thereby changing the range of dispersion of the detection target objects 111.

For example, when the user presses the exterior body 110 from above and below, as illustrated in part (a) of FIG. 8, the detection range of the detection target objects 111 is dispersed over a range smaller than the distance RE, and the concentration of the detection target objects 111 is increased. Meanwhile, when the user presses the exterior body 110 from the left and right, as illustrated in part (b) of FIG. 8, the detection range of the detection target objects 111 is dispersed over a range greater than the distance RE, and the concentration of the detection target objects 111 is increased. In parts (a) and (b) of FIG. 8, the initial detection range of the detection target objects 111 (in a state where no pressing force is applied) and the shape of the exterior body 110 are indicated by the dashed lines.

Consequently, the processor 131 is able to detect a user operation according to the dispersion range and concentration of targets corresponding to the detection target objects 111, and generate the operation information describing the detected user operation.

Note that it is assumed here that the detection target objects 111 are uniformly dispersed inside the exterior body 110. However, the present embodiment is not limited to such an assumption. Alternatively, dispersion concentration may be varied such that a larger number of detection target objects are dispersed on the side relatively close to the radar sensor 12 than on the side relatively far from the radar sensor 12. In the following description, detection target objects such as metal-coated fillers unevenly dispersed in the filling material are differentiated as detection target objects 111′ in the drawings (the dispersion range of the detection target objects 111′ is indicated by the dashed lines in the drawings).

In this example, in the state where the exterior body 110 of the interaction device 1 is not deformed, such as when the user is in contact with the interaction device 1 or stroking the surface of the interaction device 1, the detection target objects 111′ are detected at locations inside the exterior body 110 that are relatively close to (at a small distance from) the radar sensor 12.

Also in this example, when the user presses the exterior body 110 from above and below, as illustrated in part (a) of FIG. 8, the detection range of the detection target objects 111′ is dispersed over a range closer to the radar sensor 12 (smaller than a distance RP) than the initial dispersion range (the range of up to the distance RP in part (a) of FIG. 8), and the concentration of the detection target objects 111′ is increased.

Meanwhile, when the user presses the exterior body 110 from the left and right, as illustrated in part (b) of FIG. 8, the detection range of the detection target objects 111′ is dispersed over a range greater than the distance RP, and the concentration of the detection target objects 111′ is increased.

Also in this example, the processor 131 is able to detect a user operation according to the dispersion range and concentration of targets corresponding to the detection target objects 111′, and generate the operation information describing the detected user operation. Further, in this example, as illustrated in part (a) of FIG. 8, a target (user's hand) H is also detected within a range that is close to the distance RE and closer to the radar sensor 12 than the distance RE. In an example where the dispersion range of the detection target objects 111 is non-uniform as described above, the user's hand and the detection target objects 111′ can be detected and distinguished from each other.

### Example of Another Object Disposed Outside Exterior Body

In the foregoing description, a part of the user's body (e.g., a hand) is cited as an example of a target that is located at a distance greater than the distance RE, that is, located outside the exterior body 110. In the present embodiment, however, the target located at a distance greater than the distance RE is not limited to a part of the user's body.

For example, the radar sensor 12 of the interaction device 1 according to the present embodiment may detect another interaction device 1 that is located outside the exterior body 110. In this example, when the processor 131 finds a portion of the shape of the exterior body 110 of the interaction device 1 according to a detection result received from the radar sensor 12 or finds a portion of the shape and is able to perform near-field communication with the other interaction device 1 through the communication section 133, the processor 131 may perform a predetermined process.

In this example, when the interaction devices 1 are disposed side by side, it is possible, for example, to perform an operation of, for example, generating a predetermined sound.

### REFERENCE SIGNS LIST

1: Interaction device
2: Information processing device
11: Device main body
12: Radar sensor
13: Circuit section
110: Exterior body
111: Detection target object
131: Processor
132: Storage section
133: Communication section

1. An interaction device further comprising:
a main body that is deformable;
a radar sensor disposed on an a side of one inner surface of the main body, the radar sensor being configured to detect a location of a target within a detection range that is predetermined and extended from the one inner surface, the detection range including an inside of the main body, to an outside of the main body opposite the one inner surface; and
a first detection target object disposed inside of the main body and within the detection range, the detection target object being configured to move in response to deformation of the main body,
wherein the location of the target detected by the radar sensor is subjected to predetermined processing.

2. The interaction device according to claim 1,
wherein the one inner surface on which the radar sensor is disposed is a bottom surface of the main body, and the detection range is a predetermined range above the bottom surface of the main body.

3. The interaction device according to claim 1,
wherein the one inner surface on which the radar sensor is disposed is a bottom surface of the main body, and the detection range is a predetermined range above the bottom surface of the main body, and
the first detection target object includes a portion projecting into the inside of the main body, and the first detection target is positioned at a predetermined distance from an upper surface of the main body.

4. The interaction device according to claim 3,
wherein the first detection target object has a cantilever shape that projects into the inside of the main body from a base that moves according to the deformation of the main body.

5. The interaction device according to claim 1,
wherein the inside of the main body is filled with a filling material that is not to be detected by the radar sensor.

6. The interaction device according to claim 5,
further comprising a plurality of detection target objects to be detected by the radar sensor,
wherein the plurality of detection target objects includes the first detection target object, and
the plurality of detection target objects are dispersedly disposed in the filling material.

7. The interaction device according to claim 6,
wherein the plurality of detection target objects are dispersed on a first side of the main body that is closer to the radar sensor than on a second side of the main body.

8. The interaction device according to claim 1,
further comprising a plurality of the detection target objects,
wherein the plurality of detection target objects includes the first detection target object.

9. The interaction device according to claim 1,
wherein the radar sensor detects, as the target, both the first detection target object and an object located outside the main body.

10. The interaction device according to claim 1, wherein the detection range includes a bottom surface of the main body and has an inverted cone shape.

11. An interaction device further comprising:
a main body that is deformable;
a radar sensor disposed inside of the main body, the radar sensor being configured to detect information regarding a target within a detection range, the detection range including an inside of the main body to an outside of the main body;
a first detection target object disposed inside of the main body within the detection range, the first detection target object being configured to move in response to deformation of the main body; and
a processor configured to:
receive the information regarding the target detected by the radar sensor, and
determine a user operation based on the received location.

12. The interaction device according to claim 11, wherein the processor is further configured to determine a movement direction of the target based on the received information.

13. The interaction device according to claim 11, wherein the processor is further configured to determine, based on the received information:
a first state where the target is close to the main body,
a second state where the target is in contact with the main body,
a third state where the target is moving while maintaining contact with the main body.

14. The interaction device according to claim 13, wherein the processor is further configured to determine, based on the received information:
a fourth state where the target is pressing the main body along a vertical axis, and
a fifth state where the target is pressing the main body along a horizontal axis, the vertical axis being perpendicular to horizontal axis.

15. The interaction device according to claim 11, wherein the radar sensor is disposed on a bottom surface of the main body.

16. The interaction device according to claim 15, wherein the inside of the main body is filled with a filling material that is not to be detected by the radar sensor, and
the filling material deforms in response to deformation of the main body.

17. The interaction device according to claim 16,
further comprising a plurality of detection target objects to be detected by the radar sensor,
wherein the plurality of detection target objects includes the first detection target object, and
the plurality of detection target objects are dispersedly disposed in the filling material.

18. The interaction device according to claim 11, wherein the first detection target object includes a portion projecting into the inside of the main body, and
the first detection target object is positioned at a predetermined distance from an upper surface of the main body.

19. The interaction device according to claim 18, wherein the radar sensor detects, as the target, both the first detection target object and an object located outside the main body.

20. An interaction device further comprising:
a main body that is deformable, the main body including a filling material that is not to be detected by the radar sensor;
a radar sensor disposed inside of the main body, the radar sensor being configured to detect information regarding a target within a detection range, the detection range including an inside of the main body to an outside of the main body; and
a first detection target object disposed inside of the main body within the detection range, the first detection target object being configured to move in response to deformation of the main body; and
a processor configured to:
receive the information regarding the target detected by the radar sensor,
detect a first state where the target is close to the main body,
detect a second state where the target is in contact with the main body, and
detect a third state where the target is moving while maintaining contact with the main body.
